(19) United States
(12) Patent Application Publication
(10) Pub. No.: US 2012/0105217 A1
(43) Pub. Date: May 3, 2012

(54) REMOTE DEVICE AND REMOTE CONTROL SYSTEM

(75) Inventors: Ming-Tsan KAO, Hsin-Chu (TW); Yi-Hsien KO, Hsin-Chu (TW); Chia-Cheun LIANG, Hsin-Chu (TW); Cho-Yi LIN, Hsin-Chu (TW)

(73) Assignee: PIXART IMAGING INC., Hsin-Chu (TW)

(21) Appl. No.: 13/348,311

(22) Filed: Jan. 11, 2012

Related U.S. Application Data
(63) Continuation-in-part of application No. 12/723,522, filed on Mar. 12, 2010.

(51) Int. Cl. G08C 19/12

(52) U.S. Cl. 340/13.3

(57) ABSTRACT

There is provided a remote device including an image sensing module, a processing unit, an input unit and a transmitter. The image sensing module is configured to detect at least one of a plurality of identification signals to generate an image frame. The processing unit controls the transmitter to send a control signal associated with the identification signal closest to a center of the image frame and an input signal from the input unit. There is further provided a remote control system.

### CROSS REFERENCE TO RELATED APPLICATION

This application is a continuation-in-part application of U.S. Ser. No. 12/723,522, filed on Mar. 12, 2010, the full disclosure of which is incorporated herein by reference.

### BACKGROUND

1. Field of the Invention

This disclosure generally relates to a human-machine interface system and, more particularly, to a remote device and a remote control system utilizing an image sensor.

2. Description of the Related Art

Please refer to FIG. 1, it shows a conventional indoor light control system 9. The light control system 9 includes at least one lamp 91 and at least one mechanical switch 92, wherein each mechanical switch 92 is electrically connected to at least one lamp 91 through a control line 93 so as to control the ON/OFF of the lamp 91.

However, as the mechanical switch 92 is generally installed on the surface of wall, not only the eye is offended but poor contact occurs due to frequent operation such that the mechanical switch 92 needs to be replaced from time to time. In addition, the wall surface around the switch is frequently touched when a user switches the mechanical switch 92 such that the wall is easily smudged and needs to be cleaned frequently. Furthermore, since the control line 93 has to be installed under the wall surface, not only higher cost is required during installation but the maintenance and replacement of the control line 93 will take more money and time. When the number of the lamp 91 is numerous and each lamp 91 needs to be controlled independently, a plurality of mechanical switches 92 and complicated control lines 93 are required so as to implement the independent control of each lamp 91. However, the operating complexity and installation cost will be significantly increased.

In addition, an electronic device generally includes a plurality of buttons associated to different operating functions, and a user needs to operate the electronic device itself in order to change a current operating function or to execute a specific function. Although conventionally it is able to perform the control through a remote controller, how to identify different electronic devices if as user wants to control different electronic devices with a single remote controller is a problem needs to be solved.

Accordingly, it is necessary to further provide a remote device and a remote control system so as to solve the problems existed in controlling different electronic devices mentioned above.

### SUMMARY

The present disclosure provides a remote device and a remote control system capable of identifying and controlling different electronic devices.

The present disclosure further provides a remote device and a remote control system capable of identifying different electronic devices and controlling different electronic devices according to a gesture made by a user.

The present disclosure provides a remote device including an image sensing module, at lease one input unit, a transmitter and a processing unit. The image sensing module is configured to detect at least one of a plurality of identification signals to generate an image frame. The input unit generates an input signal according to an operation of the user. The transmitter is configured to send a control signal. The processing unit is for defining the identification signal detected in the image frame and closest to a center of the image frame as a target identification signal, and for controlling the transmitter to send the control signal associated with the target identification signal and the input signal.

The present disclosure further provides a remote control system including a first electronic device, a second electronic device and a remote device. The first electronic device continuously sends a first identification signal. The second electronic device continuously sends a second identification signal. The remote device identifies the first identification signal and the second identification signal, and selects a first protocol associated with the first electronic device or a second protocol associated with the second electronic device according to the identified first or second identification signal.

The present disclosure further provides a remote control system including a plurality of home appliances and a remote device. Each of the home appliances includes a light source to continuously send an identification signal. The remote device is for being operated by a user and includes an image sensing module, at least one input unit, a transmitter and a processing unit. The image sensing module is configured to detect at least one of the identification signals to generate an image frame. The input unit generates an input signal according to an operation of the user. The transmitter is configured to send a control signal. The processing unit is for identifying the identification signals, and controlling the transmitter to send, according to a target identification signal and the input signal, the control signal to one of the home appliances associated with the target identification signal.

In the remote device and the remote control system of the present disclosure, the identification signals may be red light or infrared light, and have different illumination patterns, wherein the different illumination patterns may be different frequencies, different intensities and/or different illumination intervals.

In the remote device and the remote control system of the present disclosure, the input unit may be at least one of a button, a touch pad, a roller, a finger mouse and a joystick; or the input unit may be a gesture recognition unit which recognizes a gesture according to a position variation of the target identification signal in the image frame so as to generate the input signal. In one embodiment, the gesture recognition unit may be included in the processing unit.

In the remote device and the remote control system of the present disclosure, the transmitter may be an infrared light transmitter, a Bluetooth transmitter or other wireless communication units.

In the remote device and the remote control system of the present disclosure, the processing unit previously stores different protocols associated with different identification signals, different electronic devices or different home appliances so as to control the transmitter to send the corresponding control signal according to different protocols. The remote device may be a home appliance remote controller or a portable electronic device.

### BRIEF DESCRIPTION OF THE DRAWINGS

Other objects, advantages, and novel features of the present invention will become more apparent from the following detailed description when taken in conjunction with the accompanying drawings.

FIG. 1 shows a schematic diagram of a conventional indoor light control system.

FIG. 2 shows a schematic diagram of the light control system in accordance with an embodiment of the present invention.

FIG. 3a shows a schematic diagram of the illumination module in accordance with an embodiment of the present invention.

FIG. 3b shows a schematic diagram of the illumination module in accordance with another embodiment of the present invention.

FIG. 4 shows a schematic diagram of identification signals emitted by different illumination modules included in the light control system in accordance with the embodiment of the present invention.

FIG. 5 shows a flow chart of the control method of a light control system in accordance with an embodiment of the present invention.

FIG. 6 shows a flow chart of the control method of a light control system in accordance with another embodiment of the present invention.

FIG. 7 shows a schematic diagram of controlling the ON/OFF of an illumination module with a remote controller included in the light control system in accordance with the embodiment of the present invention.

FIG. 8 shows a schematic diagram of controlling the ON/OFF of a plurality of illumination modules with a remote controller included in the light control system in accordance with the embodiment of the present invention.

FIG. 9 shows another schematic diagram of controlling the ON/OFF of a plurality of illumination modules with a remote controller included in the light control system in accordance with the embodiment of the present invention.

FIG. 10 shows another schematic diagram of controlling the ON/OFF of a plurality of illumination modules with a remote controller included in the light control system in accordance with the embodiment of the present invention.

FIG. 11 shows a schematic block diagram of the remote device according to an alternative embodiment of the present disclosure.

FIG. 12 shows a schematic block diagram of the remote control system according to an alternative embodiment of the present disclosure.

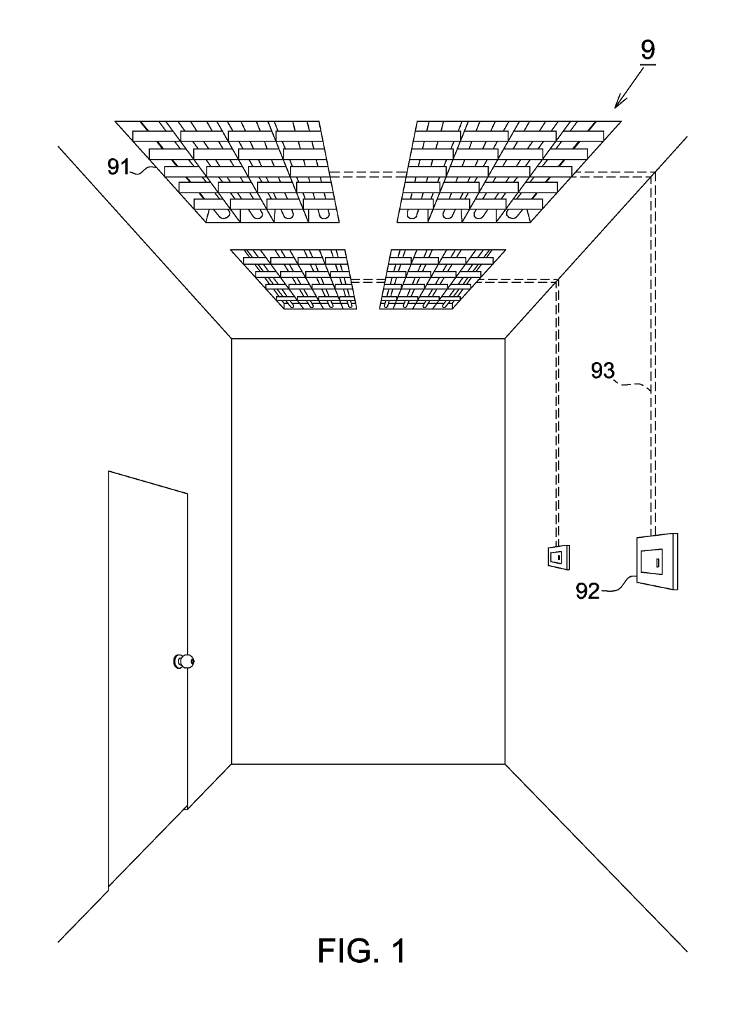

### DETAILED DESCRIPTION OF THE EMBODIMENT

It should be noticed that, wherever possible, the same reference numbers will be used throughout the drawings to refer to the same or like parts.

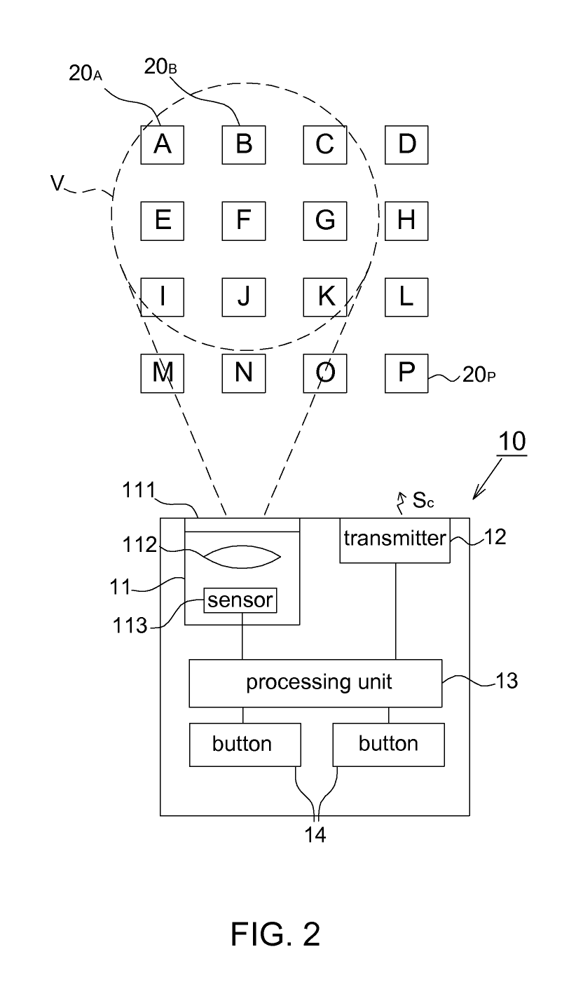

Please refer to FIG. 2, it shows a schematic diagram of the light control system according to an embodiment of the present invention. The light control system includes a remote controller 10 and a plurality of illumination modules 20, e.g. illumination modules 20_{A}˜20_{P}. The remote controller 10 is configured to control the ON/OFF of the light source included in one or a part of the illumination modules 20.

The remote controller 10 includes an image sensing module 11, a transmitter 12, a processing unit 13 and at least one button 14, wherein the processing unit 13 is coupled to the image sensing module 11, the transmitter 12 and the button 14. The image sensing module 11 is configured to acquire images of an identification signal emitted from the illumination modules 20. The transmitter 12 is configured to send a wireless control signal Sc to the illumination modules 20 so as to accordingly control the illumination modules 20 to emit the identification signal or to control the ON/OFF of the light source included in the illumination modules 20, wherein the transmitter 12 may communicate with the illumination modules 20 through, for example Bluetooth or the like, to implement the transmission of the wireless control signal Sc. The processing unit 13 is configured to control the image sensing module 11 to start to or stop acquiring images, to identify different illumination modules 20 according to the images of the identification signals acquired by the image sensing module 11, and to control the transmitter 12 to send the wireless control signal Sc. The button 14 is configured for being pressed by a user (not shown) to enable the operation of the light control system.

For example in an embodiment, when the button 14 is pressed continuously, the processing unit 13 controls the transmitter 12 to emit a first wireless control signal Sc₁ to the illumination modules 20 to have them emit the identification signal; meanwhile the processing unit 13 controls the image sensing module 11 to acquire images with a sampling frequency. When the button 14 is released from the pressed state, the processing unit 13 controls the transmitter 12 to send a second wireless control signal Sc₂ to the illumination modules 20 so as to accordingly control the ON/OFF of the light source included in one or a part of the illumination modules 20.

In another embodiment, when the button 14 is pressed the first time, the processing unit 13 controls the transmitter 12 to send a first wireless control signal Sc₁ to the illumination modules 20 to have them emit an identification signal; meanwhile the processing unit 13 controls the image sensing module 11 to acquire images with a sampling frequency. When the button 14 is pressed the second time, the processing unit 13 controls the transmitter 12 to send a second wireless control signal Sc₂ to the illumination modules 20 so as to accordingly control the ON/OFF of the light source included in one or a part of the illumination modules 20. It is appreciated that, the operation corresponding to the method of pressing the button 14 may be set according to actual applications and is not limited to those described herein.

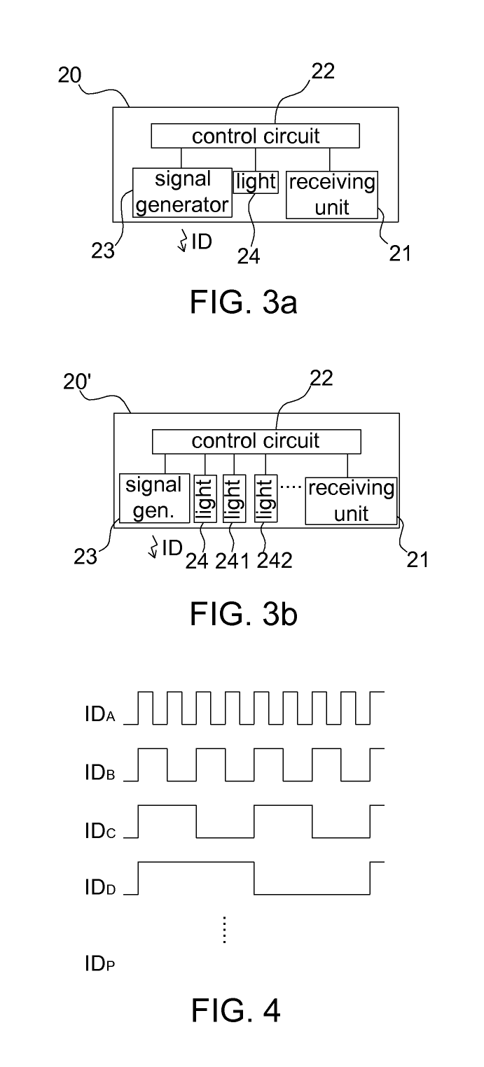

Please refer to FIGS. 3a and 3b, they respectively show a schematic diagram of the illumination module 20 according to an embodiment of the present invention. An illumination module 20 includes a receiving unit 21, a control circuit 22, an identification signal generator 23 and a light source 24, wherein the control circuit 22 is coupled to the receiving unit 21, the identification signal generator 23 and the light source 24. FIG. 3b shows the illumination module 20′ according to another embodiment of the present invention, which includes a plurality of light sources 24, 241, 242, and so on.

The receiving unit 21 is configured to receive the wireless control signal Sc sent from the transmitter 12 of the remote controller 10, wherein the signal transmission and communication between the transmitter 12 and the receiving unit 21 may be implemented by wireless communication techniques, e.g. Bluetooth or the like. When the control circuit 22 confirms that the receiving unit 21 receives the first wireless control signal Sc₁ from the remote controller 10, the control circuit 22 controls the identification signal generator 23 to emit an identification signal ID. When the control circuit 22 confirms that the receiving unit 21 receives the second wireless control signal Sc₂ from the remote controller 10, the control circuit 22 controls the ON/OFF of the light source 24 (and/or 241, 242, and so on). Embodiments of the identification signal generates 23 include a light emitting diode (LED), an infrared light emitting diode (IR LED) and a laser diode (LD). The identification signal generator 23 of each illumination module 20 is controlled by corresponding control circuit 22 to emit invisible light, e.g. an infrared light or an ultraviolet light, with a modulation frequency to be served as the identification signal ID. Embodiments of the light source 24 include, but not limited to, a fluorescent light, an incandescent lamp, a halogen light, a light emitting diode, an organic light emitting diode and their composition.

Please refer to FIGS. 2 and 4, FIG. 4 shows the modulated invisible lights, which are served as the identification signal ID of different illumination modules 20, emitted by the identification signal generator 23 of some illumination modules 20 according to the embodiment of the present invention, wherein ID_{A} refers to the identification signal of the illumination module 20_{A}; ID_{B} refers to the identification signal of the illumination module 20_{B}, and so on. In this embodiment, the frequency of ID_{A} is two times of that of ID_{B}, the frequency of ID_{B} is two times of that of ID_{C}, and so on. In another embodiment, the modulation frequency of the identification signal ID emitted by the identification signal generator 23 of each illumination module 20 is preferably a multiple, e.g. 1.5 times, 2 times, 2.5 times, 3 times, and so on, of that of other illumination modules 20.

The image sensing module 11 further includes a filter 111, a lens (or lens set) 112 and an image sensor 113. The filter 111 is for blocking the light with a spectrum outside the spectrum of the invisible light emitted by the identification signal generator 23 so as to eliminate the interference from ambient light. The lens 112 is for adjusting the sensing efficiency of the image sensor 113. Embodiments of the image sensor 113 include, but not limited to, a CCD image sensor and a CMOS image sensor. The image sensor 113 has a field of view V and is for acquiring the invisible light emitted by the identification signal generator 23 of the illumination modules 20 inside the field of view V to generate a plurality of images, and sends the acquired images to the processing unit 13. The processing unit 13 identifies different illumination modules 20 according to different modulation frequencies (e.g. those shown in FIG. 4). It is appreciated that, in order to allow the image sensor 113 to regularly acquire images of the identification signal ID emitted by all identification signal generators 23, the sampling frequency of the image sensor 113 is preferably synchronize to and a common multiple of the modulation frequencies of all identification signals ID. It is appreciated that, a shape of the field of view V is not limited to a circle, and FIG. 2 is only exemplary rather than a limitation of the present invention.

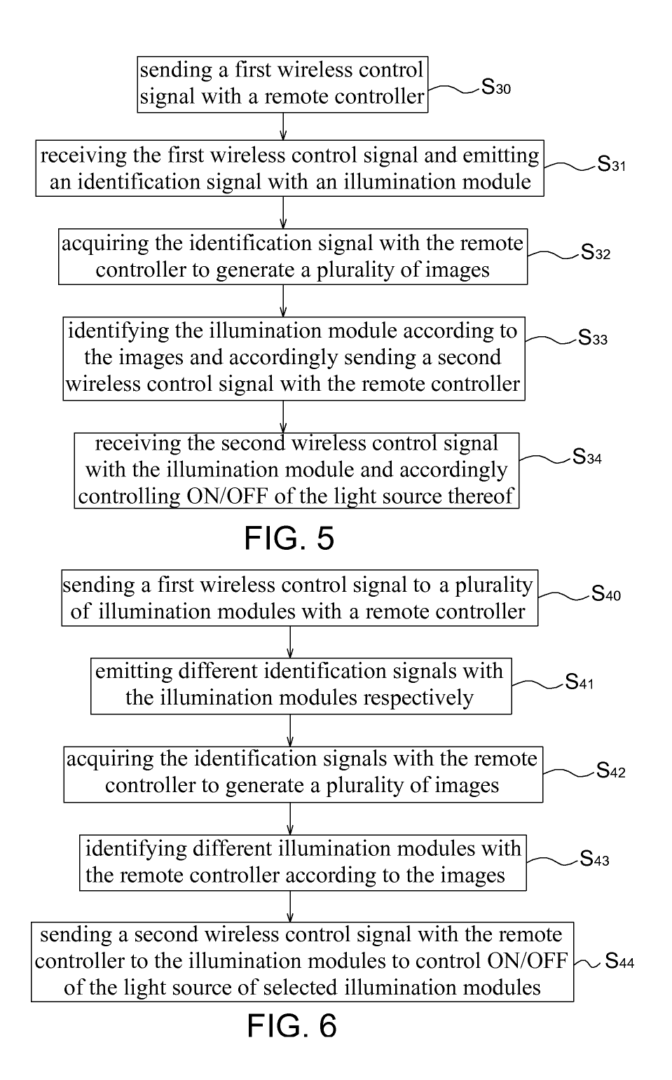

Please refer to FIG. 5, it shows a flow chart of the control method of a light control system in accordance with an embodiment of the present invention. The control method includes the steps of: sending a first wireless control signal with the remote controller (Step S₃₀); receiving the first wireless control signal and emitting an identification signal with an illumination module (Step S₃₁); acquiring the identification signal with the remote controller to generate a plurality of images (Step S₃₂); identifying the illumination module according to the images and accordingly sending a second wireless control signal with the remote controller (Step S₃₃); and receiving the second wireless control signal with the illumination module and accordingly controlling the ON/OFF of the light source thereof (Step S₃₄).

Next, details of the control method shown in FIG. 5 will be illustrated hereinafter. Please refer to FIGS. 2, 3 and 5, when a user (not shown) would like to control the ON/OFF of at least one of the illumination modules 20_{A}˜20_{P}, the user points the remote controller 10 to at least one illumination module 20 and presses the button 14 on the remote controller 10 to have the processing unit 13 control the transmitter 12 to send a first wireless control signal Sc₁ (Step S₃₀). All illumination modules 20_{A}˜20_{P} will receive the first wireless control signal Sc₁. When the control circuit 22 of every illumination module 20 confirms the first wireless control signal Sc₁, the control circuit 22 controls corresponding identification signal generator 23 to emit an identification signal ID, e.g. the illumination module 20_{A} emits an identification signal ID_{A}, the illumination module 20_{B} emits an identification signal ID_{B}, and so on. (Step S₃₁). The image sensor 113 of the remote controller 10 acquires the identification signal ID of the illumination module 20 inside the field of view V thereof, e.g. the illumination module 20_{A}, with a sampling frequency so as to generate a plurality of images, wherein the sampling frequency is preferably synchronize to and a multiple of the frequency of the identification signal ID such that the image sensor 113 may regularly acquire images of the identification signal ID emitted from the identification signal generator 23 (Step S₃₂).

In this manner, the processing unit 13 may identify the identification signal ID from different illumination modules 20 according to the frequency (i.e. regularity) of the image of the identification signal ID appeared in the captured images. Next, the processing unit 13 controls the transmitter 12 to send a corresponding second wireless control signal Sc₂. (Step S₃₃), wherein the frequency of the second wireless control signals Sc₂ for different illumination modules 20 may be different from each other. For example, in an embodiment, the frequency of the second wireless control signal Sc₂ may be identical to that of the identification signal ID_{A} of the illumination module 20_{A} when it is desired to enable the illumination module 20_{A}, but the present invention is not limited to this. After the control circuit 22 of the illumination module 20 inside the field of view V, e.g. the illumination module 20_{A}, confirms its corresponding receiving unit 21 receives the second wireless control signal Sc₂, the control unit 22 controls the ON/OFF of the corresponding light source 24 (Step S₃₄).

Please refer to FIG. 6, it shows a flow chart of the control method of a light control system in accordance with another embodiment of the present invention. The control method includes the steps of: sending a first wireless control signal to a plurality of illumination modules with the remote controller (Step S₄₀); emitting different identification signals with the illumination modules respectively (Step S₄₁); acquiring the identification signals with the remote controller to generate a plurality of images (Step S₄₂); identifying different illumination modules with the remote controller according to the images (Step S₄₃); sending a second wireless control signal with the remote controller to the illumination modules to control the ON/OFF of the light source of selected illumination modules according to an identification result (Step S₄₄).

Next, details of the control method shown in FIG. 6 will be illustrated hereinafter. Please refer to FIGS. 2, 3 and 6, when a user would like to control the ON/OFF of a plurality of illumination modules 20_{A}˜20_{P} simultaneously, e.g. the ON/OFF of the illumination modules 20_{A}˜20_{C}, 20_{E}˜20_{G} and 20_{I}˜20_{K}, the user points the remote controller 10 to the illumination modules 20_{A}˜20_{C}, 20_{E}˜20_{G} and 20_{I}˜20_{K} and presses the button 14 on the remote controller 10 to have the processing unit 13 control the transmitter 12 to send a first wireless control signal Sc₁. All of the illumination modules 20 will receive the first wireless control signal Sc₁ (Step S₄₀). When the control circuit 22 of every illumination module 20 confirms the first wireless control signal Sc₁, the control circuit 22 controls corresponding identification signal generator 23 to emit identification signals ID_{A}˜ID_{P}, wherein the identification signals ID are modulated invisible light with a predetermined modulation frequency (Step S₄₁). The image sensor 113 of the remote controller 10 acquires, with a sampling frequency, the identification signals, e.g. ID_{A}˜ID_{C}, ID_{E}˜ID_{G} and ID_{I}˜ID_{K}, emitted from the identification signal generator 23 of the illumination modules, e.g. 20_{A}˜20_{C}, 20_{E}˜20_{G} and 20_{I}˜20_{K} as shown in FIG. 2, inside the field of view V thereof to generate a plurality of images (Step S₄₂); wherein the sampling frequency is preferably synchronize to and a common multiple of those modulation frequencies such that the image sensor 113 may regularly acquire images of the identification signal ID emitted from the identification signal generator 213 of the illumination modules 20. Accordingly, the processing unit 13 may identify the identification signal ID from different illumination modules, e.g. 20_{A}˜20_{C}, 20_{E}˜20_{G} and 20_{I}˜20_{K}, according to the frequency (regularity) of the identification signal ID appeared in the captured images so as to identify different illumination modules 20 (Step S₄₃). In an embodiment, the processing unit 13 may identify a selected part of the identification signals whose image are included in the captured images according to a predetermined rule (details will be illustrated below) rather than identify all identification signals included in the captured images. Finally, the processing unit 13 controls the transmitter 12 to send a corresponding second wireless control signal Sc₂ so control the ON/OFF of the light source included in the selected illumination modules; wherein the second wireless control signal Sc₂ for different illumination modules 20 may have different frequencies.

In the present invention, the above mentioned predetermined rule is that the processing unit 13 processes the part inside a predetermined window of interest (WOI) of the captured images and ignores other parts. The step of setting the WOI may be performed before Step S₄₃. That is, when the WOI in the captured images is selected, the remote controller 10 identifies the illumination modules 20 inside the selected WOI according to the captured images and sends a second wireless control signal Sc₂ to the illumination modules 20 to control the ON/OFF of the light source 24 of the illumination modules inside the selected WOI, e.g. 20_{A}˜20_{C}, 20_{E}˜20_{G} and 20_{I}˜20_{K}.

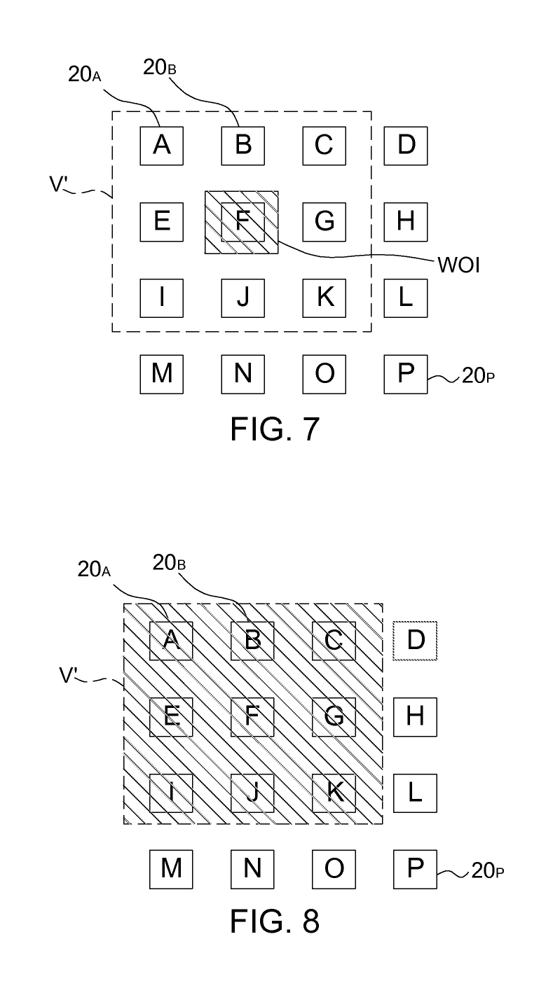

Please refer to FIG. 7, for example in an embodiment, the processing unit 13 is preset only to process the center part of a field of view V′ (shown as a square herein) and to ignore other image information inside the field of view V′. Accordingly, when the remote controller 10 sends the first wireless control signal Sc₁, the identification signal generator 23 of the illumination modules 20_{A}˜20_{P} emits light according to their own modulation frequencies. The image sensor 113 then acquires images of the identification signal generator 23 inside the field of view V′ and transmits the captured images to the processing unit 13. Since the processing unit 13 is preset to only process the image information inside the WOI, the processing unit 13 only identifies the identification signal ID_{F} from the illumination module 20_{F}. Next, the processing unit 13 sends a second wireless control signal Sc₂ to the illumination module 20_{F} to turn on or turn off the light source 24 (241, 242, and so on) included therein.

Please refer to FIG. 8, it shows that the WOI processed by the processing unit 13 is preset as the whole area of the field of view V′. Therefore, when the remote controller 10 sends the first wireless control signal Sc₁, the identification signal generator 23 of the illumination modules 20_{A}˜20_{P} emits light according to their own modulation frequencies. The image sensor 113 then acquires images of the identification signal generator 23 inside the field of view V′ and transmits the captured images to the processing unit 13. After the processing unit 13 identifies the identification signals ID_{A}˜ID_{C}, ID_{E}˜ID_{G} and ID_{I}˜ID_{K} in the captured images, it controls the transmitter 12 to sequentially send the second wireless control signal Sc₂ with frequencies identical to the modulation frequencies of the identification signals ID_{A}˜ID_{C}, ID_{E}˜ID_{G} and ID_{I}˜ID_{K}, e.g. sending the second wireless control signal Sc₂ in a sequence of Sc_{2A}, Sc_{2B}, Sc_{2C}, Sc_{2E}, Sc_{2F}, Sc_{2G}, Sc_{2I}, Sc_{2J}, Sc_{2K}, wherein Sc_{2A} refers to the second wireless control signal Sc₂ with the frequency identical to the modulation frequency of the identification signal ID_{A}; Sc_{2B} refers to the second wireless control signal Sc₂ with the frequency identical to the modulation frequency of the identification signal ID_{B}; Sc_{2C} refers to the second wireless control signal Sc₂ with the frequency identical to the modulation frequency of the identification signal ID_{C}, and so on. After the control circuit 22 of the illumination modules 20_{A}˜20_{C}, 20_{E}˜20_{G} and 20_{I}˜20_{K} confirms the receiving of corresponding second wireless control signal Sc₂, it controls the ON/OFF of the corresponding light source 24.

It is appreciated that the frequency of the second wireless control signal Sc₂ sent from the transmitter 12, which is controlled by the processing unit 13, is not limited to be identical to the modulation frequency of the identification signal ID. In another embodiment, as long as the control circuit 22 is preset to be able to identify corresponding frequency, the frequency of the second wireless control signal Sc₂ sent by the transmitter 12 may not be equal to the modulation frequency of the identification signal ID. Furthermore, the sequence of the frequencies that the processing unit 13 controls the transmitter 12 to send the second wireless control signal Sc₂ mentioned above is only exemplary and is not a limitation of the present invention.

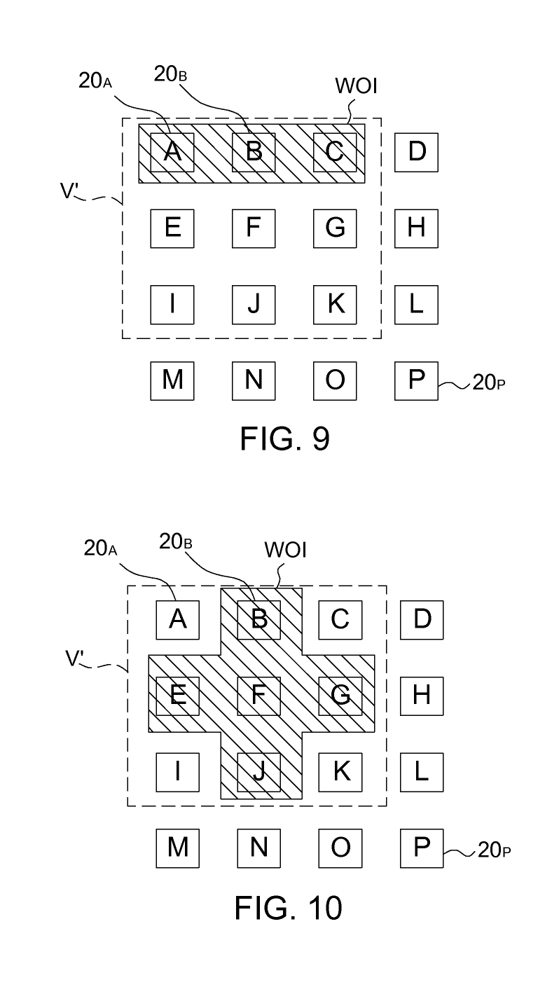

It is appreciated that the preset WOI processed by the processing unit 13 is not limited to those shown in FIGS. 7 and 8. For example in FIG. 9, the WOI may be preset as the upper part of the field of view V′; wherein the method that the remote controller 10 controls the ON/OFF of the illumination modules 20_{A}˜20_{C} is similar to that shown in FIG. 8 and thus details will not be repeated herein. In another embodiment, as shown in FIG. 10, the WOI may be preset as the middle part of the field of view V′ along the vertical and horizontal directions to form a cruciate region; wherein the method that the remote controller 10 controls the ON/OFF of the illumination modules 20_{B}, 20_{E}˜20_{G} and 20_{J} is similar to that shown in FIG. 8 and thus details will not be repeated again.

Another embodiment of the present disclosure provides a remote device for being operated by a user to control at least one electronic device or at least one home appliance. Therefore, the remote device may be a home appliance remote controller or a portable electronic device, wherein the home appliance may be image display devices, air conditioners, temperature controlling equipments, multimedia devices and lighting equipments which are generally used in a family or an office.

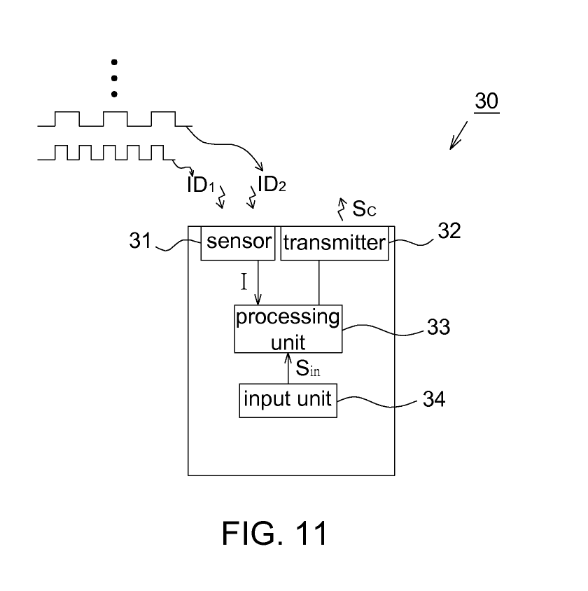

Please refer to FIG. 11, it shows a schematic block diagram of the remote device according to an alternative embodiment of the present disclosure. The remote device 30 includes an image sensing module 31, a transmitter 32, a processing unit 33 and an input unit 34.

The image sensing module 31 is configured to detect at least one of a plurality of identification signals, e.g. ID₁, ID₂ . . . , and generate an image frame I, wherein the identification signals ID₁, ID₂ . . . may be red light, infrared light or other invisible light and have different illumination patterns. The different illumination patterns mentioned herein may be, for example, different frequencies, different intensities, different illumination intervals, and etc.

The at least one input unit 34 generates an input signal Sᵢₙ to the processing unit 33 according to an operation of a user (not shown), wherein the input unit 34 may be at least one of a button, a touch pad, a roller, a finger mouse and a joystick, but not limited thereto. It is appreciated that the input signal Sᵢₙ generated by the input unit 34 is different according to a type of the input unit 34, e.g. a pressing signal, a touch signal, a motion vector, a direction signal, a moving velocity, and etc. In another embodiment, the input unit 34 may be a gesture recognition unit which recognizes a gesture according to a position variation and/or a direction of variation of a target identification signal (described later) in the image frame I so as to generate the input signal Sᵢₙ, wherein the gesture recognition unit may be included in the processing unit 33; that is, when an identification signal exists in the image frame I and if the user changes the position of the remote device 30, a position of the identification signal will change at the same time such that the gesture recognition unit is able to recognize different gestures, wherein the function associated to every gesture may be defined in the protocol previously.

The transmitter 32 is configured to send a control signal Sc, wherein the transmitter 32 may be an infrared light transmitter, a Bluetooth transmitter or other wireless communication units.

The processing unit 33 is for identifying the identification signals ID₁, ID₂. When the image frame I contains a plurality of the identification signals ID₁, ID₂ . . . , the processing unit 33 defines one of the identification signals closest to a center of the image frame I as a target identification signal and controls the transmitter 32 to send the control signal Sc associated with the target identification signal and the input signal Sᵢₙ to a home appliance or an electronic device associated with the target identification signal; In another embodiment, the processing unit 33 may determine the target identification signal according to system requirements or system settings, i.e. the target identification signal may not be the identification signal closest to the center of the image frame I but may be determined according to predetermined rules. It is appreciated that when the image frame I contains only one of the identification signals ID₁, ID₂, the target identification signal is the one contained in the image frame I. As mentioned above, since the remote device 30 is configured to control different electronic devices or home appliances, the processing unit 30 preferably stores different protocols associated with different identification signals previously so as to control the transmitter 32 to output the corresponding control signal Sc associated with different protocols.

Another embodiment of the present disclosure provides a remote control system, and a user (not shown) may use the remote device 30 to identify and relatively control at least one electronic device or at least one home appliance.

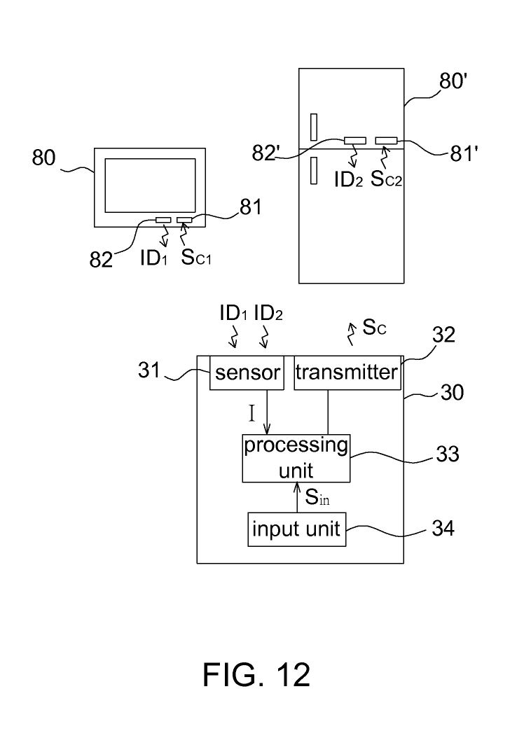

Please refer to FIG. 12, it shows a schematic block diagram of the remote control system according to an alternative embodiment of the present disclosure. The remote control system is composed of a plurality of (e.g. two are shown in FIG. 12) electronic devices or home appliances and the remote device 30, wherein the electronic devices or the home appliances are shown as a TV 80 and a refrigerator 80′ herein, but the present disclosure is not limited thereto.

The TV 80 continuously sends a first identification signal ID₁ through a first identification signal generator 82, and the refrigerator 80′ continuously sends a second identification signal ID₂ through a second identification signal generator 82′, wherein the identification signal generators 82 and 82′ of the TV 80 and the refrigerator 80′ may be light sources configured to continuously emit the identification signals ID₁ and ID₂, wherein the light sources may be light emitting diodes or laser diodes.

The remote device 30 identifies the first identification signal ID₁ and the second identification signal ID₂, and selects a first protocol associated with the first electronic device (e.g. the TV 80) or selects a second protocol associated with the second electronic device (e.g. the refrigerator 80′) according to the identified first identification signal ID₁ or the second identification signal ID₂; that is, the first protocol is selected when the first identification signal ID₁ is identified while the second protocol is selected when the second identification signal ID₂ is identified.

As mentioned above, the remote device 30 includes the image sensing module 31, the transmitter 32, the processing unit 33 and the at least one input unit 34. The remote device 30 sends a first control signal Sc₁ to a receiving unit 81 of the first electronic device (e.g. the TV 80) according to the first protocol and the input signal Sᵢₙ, or sends a second control signal Sc₂ to a receiving unit 81′ of the second electronic device (e.g. the refrigerator 80′) according to the second protocol and the input signal Sᵢₙ. Therefore in the present embodiment, the processing unit 33 preferably stores different protocols associated with different home appliances or different electronic devices (i.e. different identification signals) previously so as to control the transmitter 32 to send a corresponding control signal Sc according to different protocols to the home appliance or the electronic device associated to a target identification signal, wherein a method of determining the target identification signal and the operation of the remote device 30 have been described in the illustration associated with FIG. 11, and thus details thereof will not be repeated herein.

As mentioned above, conventional remote controllers are not able to identify different electronic devices and thus unable to be used to control a plurality of electronic devices at the same time. The present disclosure further provides a remote device (FIG. 11) and a remote control system (FIG. 12) that may identify different electronic devices or home appliances according to different illumination patterns of the identification signals, and respectively control different electronic devices or home appliances according to predefined protocols. In addition, the remote device of the present disclosure may further control different electronic devices or home appliances according to a gesture made by a user without using any button.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A remote device, for being operated by a user, the remote device comprising:
an image sensing module configured to detect at least one of a plurality of identification signals to generate an image frame;
at lease one input unit generating an input signal according to an operation of the user;
a transmitter configured to send a control signal; and
a processing unit for defining the identification signal detected in the image frame and closest to a center of the image frame as a target identification signal, and for controlling the transmitter to send the control signal associated with the target identification signal and the input signal.

2. The remote device as claimed in claim 1, wherein the identification signals are red light or infrared light, and have different illumination patterns.

3. The remote device as claimed in claim 1, wherein the input unit is at least one of a button, a touch pad, a roller, a finger mouse and a joystick.

4. The remote device as claimed in claim 1, wherein the transmitter is an infrared light transmitter or a Bluetooth transmitter.

5. The remote device as claimed in claim 1, wherein the processing unit stores different protocols associated with different identification signals.

6. The remote device as claimed in claim 1, which is a home appliance remote controller or a portable electronic device.

7. The remote device as claimed in claim 1, wherein the input unit is a gesture recognition unit which recognizes a gesture according to a position variation of the target identification signal in the image frame to generate the input signal.

8. A remote control system, comprising:
a first electronic device continuously sending a first identification signal;
a second electronic device continuously sending a second identification signal; and
a remote device identifying the first identification signal and the second identification signal, and selecting a first protocol associated with the first electronic device or a second protocol associated with the second electronic device according to the identified first or second identification signal.

9. The remote control system as claimed in claim 8, wherein the remote device further comprises at least one input unit configured to generate an input signal according to an operation of a user; and the remote device sends a first control signal to the first electronic device according to the first protocol and the input signal or sends a second control signal to the second electronic device according to the second protocol and the input device.

10. The remote control system as claimed in claim 9, wherein the input unit is at least one of a button, a touch pad, a roller, a finger mouse and a joystick.

11. The remote control system as claimed in claim 8, wherein the first and second identification signals are red light or infrared light, and have different illumination patterns.

12. The remote control system as claimed in claim 8, wherein the remote device is a home appliance remote controller or a portable electronic device.

13. A remote control system, comprising:
a plurality of home appliances each comprising a light source to continuously send an identification signal; and
a remote device for being operated by a user, the remote device comprises:
an image sensing module configured to detect at least one of the identification signals to generate an image frame;
at least one input unit generating an input signal according to an operation of the user;
a transmitter configured to send a control signal; and
a processing unit for identifying the identification signals, and controlling the transmitter to send, according to a target identification signal and the input signal, the control signal to one of the home appliances associated with the target identification signal.

14. The remote control system as claimed in claim 13, wherein the identification signals are red light or infrared light, and have different illumination patterns.

15. The remote control system as claimed in claim 13, wherein the input unit is at least one of a button, a touch pad, a roller, a finger mouse and a joystick; or the input device is a gesture recognition unit which recognizes a gesture according to a position variation of the target identification signal in the image frame so as to generate the input signal.

16. The remote control system as claimed in claim 13, wherein the transmitter is an infrared light transmitter or a Bluetooth transmitter.

17. The remote control system as claimed in claim 13, wherein the processing unit stores different protocols associated with the home appliances.

18. The remote control system as claimed in claim 13, which is a home appliance remote controller or a portable electronic device.

19. The remote control system as claimed in claim 13, wherein the light sources of the home appliances are light emitting diodes or laser diodes.

20. The remote control system as claimed in claim 13, wherein when the image frame contains a plurality of the identification signals, the processing unit defines the identification signal closest to a center of the image frame as the target identification signal.
